(19) United States
(12) Patent Application Publication
(10) Pub. No.: US 2014/0277833 A1
(43) Pub. Date: Sep. 18, 2014

(54) EVENT TRIGGERED TRIP DATA RECORDER

(71) Applicant: Mighty Carma, Inc., Santa Clara, CA (US)

(72) Inventor: Saurabh Palan, Santa Clara, CA (US)

(73) Assignee: Mighty Carma, Inc., Santa Clara, CA (US)

(21) Appl. No.: 14/216,896

(22) Filed: Mar. 17, 2014

Related U.S. Application Data
(60) Provisional application No. 61/801,763, filed on Mar. 15, 2013.

(51) Int. Cl. G07C 5/00

(52) U.S. Cl. CPC G07C 5/00
USPC 701/1

(57) ABSTRACT

Technology is disclosed for performing a combination of detecting events and recording data associated with the events (“the technology”). The technology monitors for various predefined events, where the events can include any unsafe vehicle operation, any unusual objects on the road, a scenic view, a traffic incident, etc. The technology gathers and stores data associated with the predefined events when any one or more of such events are detected during the monitoring. The technology uses cameras and other sensors to gather data associated with a detected event.

### CROSS-REFERENCE TO RELATED APPLICATION

This application claims the benefit of U.S. Provisional Patent Application No. 61/801,763, entitled “EVENT TRIGGERED TRIP DATA RECORDER”, which was filed on Mar. 15, 2013, which is incorporated by reference herein in its entirety.

### TECHNICAL FIELD

Various of the disclosed embodiments relate to data monitoring and recording.

### BACKGROUND

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. Consumers are increasingly offered many types of electronic devices that can be provisioned with an array of software applications. Distinct features such as email, Internet browsing, game playing, address book, calendar, media players, electronic book viewing, voice communication, directory services, etc., increasingly are selectable applications that can be loaded on a multifunction device such as a smart phone, portable game console, or hand-held computer.

### BRIEF DESCRIPTION OF DRAWINGS

These and other objects, features and characteristics of the disclosed technology will become more apparent to those skilled in the art from a study of the following detailed description in conjunction with the appended claims and drawings, all of which form a part of this specification. In the drawings:

FIG. 1 is a block diagram providing an illustrative example of an environment and a hardware (i.e. a smart phone) in which the disclosed technology can be practiced;

FIG. 2 is a block diagram providing an illustrative example of a display of a smart phone, mounted on a windshield of a vehicle, which is turned off when the vehicle reaches a particular speed;

FIG. 3 is a flow chart of a method utilized to detect event using gathered data and storing the gathered data in response to the detected event; and

FIG. 4 is a block diagram of a computer system as may be used to implement features of some embodiments of the disclosed technology.

### DETAILED DESCRIPTION

Technology is disclosed for performing a combination of detecting events and recording data associated with the events (“the technology” or “the disclosed technology”). In embodiments, the disclosed technology can be implemented as a software application, executing on a mobile device, e.g., a smart phone, (or other hardware) mounted within a vehicle, which detects events when the vehicle is in use (or as configured) and records and catalogs the events for the driver of the vehicle (or any interested party).

In embodiments, the mobile device (executing the software application) can be mounted close to the rear view mirror of the vehicle with the use of any well-known jig. Further, the mobile device can be mounted such that any display screen of the mobile device is facing the driver of the vehicle and at least one in-built video camera within the mobile device (if available) is facing away from the driver and towards the road (if the camera and display screen orientation allow such a placement). FIG. 1 provides an illustrative example 100 of one such mobile device 102 (i.e. a smart phone) that is mounted on the windshield 104 of the car and has its display screen 106 facing the driver while a rear camera (not shown in FIG. 1) faces away from the driver (and towards the road 108).

Using such an orientation, the disclosed technology can monitor for various events using the video camera, where the events can include any unsafe vehicle operation, any unusual objects on the road, a scenic view, etc., and capture and store such events. The video camera records the events from the driver's perspective (i.e. as seen by the driver). Further, if there are other video cameras included in the mobile device in different orientations, the disclosed technology can also utilize such video cameras to monitor and record events from different angles, giving the driver records of the various events from different perspectives.

In embodiments, the disclosed technology can be implemented using a combination of one or more components, including one or more camera, e.g., video camera, infrared camera, etc.; one or more sensors, e.g., accelerometer, proximity sensors, etc.; GPS module, compass, a graphics rendering module; a general purpose computing platform; etc., where the various components can be distributed across the vehicle (or the object from which the events are captured). In embodiments, the various components are connected together, either through any well-known wireless or wired communication protocols. For instance, video cameras can be mounted across various windows of a vehicle to capture video data and communicate (wirelessly or through a wired connection) the captured data to the graphics rendering module and the general purpose computing platform, executing a portion of the disclosed technology as a software application, to process the video data for detecting/recording events of interest.

The above description of hardware utilized to implement the disclosed technology is provided for illustration purposes only and therefore, should not be considered limiting the practice of the disclosed technology to such disclosed hardware combination only. The disclosed technology can be practiced using any well-known hardware/software platform providing the various functionalities being utilized by the disclosed technology.

In embodiments, the functionalities provided by various component can be combined together to achieve the combined results of the combined hardware and such a result/hardware is within the scope of the disclosed technology. Also, the various discussion pertaining to implementing the disclosed technology using a mobile device executing a customized software applies equally to any hardware/software platform that includes the various functionalities provided by the mobile device executing the customized software.

In embodiments, when an event is detected, the disclosed technology stores a predefined duration of the video around the event as a separate video file that can be easily retrieved and viewed by the driver without having to view the entire recorded video. For example, if an event is detected at time “t” and a video of “x” duration of the event is stored, then the disclosed technology stores (x/2) duration of video (any other available sensory data that is relevant to the event as discussed below) before the event time “t” and (x/2) duration of video (any other available sensory data) after the event time “t”. In embodiments, the video data recorded around each detected event can be stored and cataloged such that the driver (or any interested party) can quickly review specific events of interest.

In embodiments, the disclosed technology can also monitor for various events using sensors. Such sensors could include those in-built within the mobile device or be an external sensor the disclosed technology can communicate with through the mobile device. Some of the sensors utilized by the disclosed technology can include accelerometer, microphone, temperature sensors, elevation sensors, proximity sensors, compass, gyroscope, barometer, etc. In embodiments, when an event is detected based on the data gathered from the sensors, the disclosed technology can catalog and store the sensed data associated with the detected event. In embodiments, the disclosed technology can also store a predefined duration of the video around the events detected by the sensors along with the sensed data.

### Event Detection

### Video Based Event Recognition

As discussed above, various events can be detected using the video data gathered using the video cameras built into the mobile device. The events can be either automatically detected by the disclosed technology based on predefined events or manually detected based on a user (i.e. driver) input. In the auto detection method, the video data is periodically analyzed to detect the occurrence of any predefined events and store the video data surrounding the detected predefined events. In embodiments, the video data can be stored in any format, including raw video data, edited video, photos, etc., in a compressed or uncompressed form, which can later be used to generate any needed multi-media content.

In embodiments, the disclosed technology maintains a fixed length of video data that was previously recorded from the present time (e.g., store and maintain only the last five minutes of the gathered video data from the current time) and discards any video data that falls outside the fixed time frame (unless any event of interest is detected within the video data outside the fixed time frame). In embodiments, the disclosed technology periodically analyzes the currently gathered video data against the previously gathered video data to detect the occurrence of any predefined events. In embodiments, the disclosed technology periodically analyzes the currently gathered video data to detect the occurrence of any predefined events.

Some of the automatically detected events can include: (1) following other vehicles at unsafe distance; (2) detecting other vehicles that performed unsafe lane changes in front of the vehicle; (3) detecting vehicle drifting or swerving; (4) detecting unusual or unsafe driving pattern; (5) detecting scenic locations, vista points or commonly photographed landmarks; (6) detecting unsafe lane departure; (7) detecting unidentified objects; (8) unrecognized lane marking or unsafe road conditions, e.g., construction, sudden merger, etc.; (9) animal activity; and (10) bicyclist or pedestrian on street in vicinity of car.

In embodiments, the disclosed technology can detect following at unsafe distance by creating images of the various objects in the video data and measuring the distance of the objects from the vehicle. In one instance, when the detected object is another vehicle and the measured distance between the vehicle and the other vehicle is less that a predefined safe following limit, the disclosed technology stores a predefined duration of the video data around the unsafe following event as a separate video file for the driver to later view. In embodiments, the disclosed technology provides a driver assessment by cataloging and storing video data associated with unsafe driving practices (such as following at unsafe distances) for the driver to later review and learn from. In embodiments, the disclosed technology utilizes the driver assessment to provide driving tips to avoid such driving practices. For example, if a driver is making unsafe lane changes (as determined by predefined measurement of various driving parameters), the disclosed technology provides the driver with a link to a video for proper lane changing.

In embodiments, the disclosed technology can detect unsafe lane changing (by the vehicle or another vehicle), vehicle drifting or swerving, unusual or unsafe driving pattern, etc. by comparing image frames, taken periodically over a given time period, from the video data and determining relative change in position of the vehicle (or another vehicle) with respect to the road. The comparison of image frames can be performed using any well-known algorithm to determine difference between two given images (e.g., object change, color composition change, etc.).

Utilizing the relative change in position of the vehicle and the time period within which the change happened (determined based on the time between the image frames being analyzed), the disclosed technology can determine if the vehicle is drifting or swerving (e.g., relative to the lane markings on the road), unusual or unsafe driving pattern (e.g., going in circles compared to general driving in a straight line), etc. Similarly, if another vehicle is in the vicinity of the vehicle, the disclosed technology can determine the relative change in position of the other vehicle (if captured in the video data) and record any data (video or sensory) of unsafe driving by the other vehicle. In one instance, such information can be utilized by the driver in the event of a collision with the other vehicle to establish cause of the collision.

In embodiments, the disclosed technology can detect scenic locations (or vista points, commonly photographed landmarks, etc.) and store video data when within the vicinity of the scenic locations. In embodiments, the disclosed technology can detect a scenic location based on geo-location information of previously identified scenic locations. Such information can either be preloaded into the disclosed technology or be retrieved from an external database the disclosed technology can communicate with through the mobile device.

In embodiments, the disclosed technology can determine the current geo-location of the vehicle utilizing a built-in GPS module within the mobile device. In embodiments, the disclosed technology can determine the current geo-location of the vehicle utilizing any GPS module in the vicinity of the vehicle which the mobile device can communicate with and determine the vehicle's current geo-location.

Based on the vehicle's present geo-location and the proximity of any previously identified scenic locations, the disclosed technology starts recording the video data (and any other gathered data of interest) and create a trip log that includes the video data. In embodiments, the trip log can embed the geo-location information, the date, the time and other identifying information along with the recorded video data (spliced by time) to capture the driver's journey through a scenic location.

In embodiments, the disclosed technology can start recording when the vehicle is within a predefined proximity from the geo-location and stop recording when the vehicle falls outside the predefined proximity. In embodiments, the disclosed technology can start recording when the vehicle is within a predefined proximity from the geo-location but stop recording after a fixed duration of time or based on other parameters, such as battery life (if running on battery) of the device housing the video camera (e.g., a smart phone), the temperature of the device housing the video camera, etc.

In embodiments, the disclosed technology can detect scenic views and store video data when such views are detected. In embodiments, the disclosed technology can detect a scenic view event by comparing the captured video data to samples of previously identified scenic view images and determining if the video data should be recorded and stored as scenic views. In embodiments, the disclosed technology can determine a scenic view event based on the color composition of the image. In one instance, the disclosed technology can compare the color composition of images by comparing the color spectrum of a captured image to that of previously identified scenic view images. When the color spectrums (identifying which colors are present in a given image) correlate within a given threshold, there is a high likelihood the driver is going through a scenic view and therefore can be captured as a scenic view. It should be noted that any well-known algorithm can be utilized to compare the color compositions of any two given images.

In embodiments, the disclosed technology can determine a scenic view event based on change in lighting composition in the gathered video data. In one instance, such change in lighting composition can be utilized to determine a sunrise or a sunset where the lighting composition changes considerably in a relatively short duration. By comparing the lighting composition change in the video data periodically (that correspond the short duration of the sunrise/sunset), a sunrise or a sunset can be detected and recorded. In embodiments, the disclosed technology can determine a scenic view event based on a predefined time of the day and a proximity (based on driver's geo-location) from a predefined scenic location.

### Sensor Based Event Recognition

In embodiments, the disclosed technology can detect events based on sensory data gathered using various sensors (as described earlier) and record the video and sensory data around the time of the detected event. In one instance, when a sudden or unexpected change in the gathered sensory data is detected, an event can be triggered, resulting in the video data and other sensory data surrounding the event being stored. In embodiments, the disclosed technology can utilize the accelerometer to detect sudden changes in acceleration, which can then indicate an event of interest that should probably be recorded and cataloged. For example, a sudden acceleration could be the result of the driver avoiding a pot hole, any road damage, an accident or a collision, an emergency braking, etc. When such sudden changes in acceleration are detected, the disclosed technology can record the video data and data from other sensors (such as microphone to pick up driver's words, direction information from compass, etc.).

In embodiments, the disclosed technology can utilize the proximity sensor to detect gestures by the driver to trigger various events that require the video data and other sensory data surrounding the event to be stored. For example, a hand wave by the driver within a zone monitored by the proximity sensor can cause sudden change within the zone, which can then be detected by the proximity sensor. The disclosed technology can then utilize the detected sudden change in the proximity sensor data to trigger recording of video and other sensory data. In embodiments, the proximity sensor can thus act as a hands-free solution to manually trigger an event when the driver wants to record video or other data.

### Additional Functionalities

In embodiments, the disclosed technology will continuously run on the mobile device as a background process without interfering with other software applications the driver might be currently utilizing. For e.g., if the driver is utilizing a navigation application, then the map of the navigation application is displayed to the driver while driving but the disclosed technology continues to run in the background and monitor and record events of interest.

In embodiments, the disclosed technology will turn on the event detection and data recording when the mobile device is within the vicinity of the vehicle. Similarly, the disclosed technology will turn off the event detection and data recording when the mobile device is outside the vicinity of the vehicle. In embodiments, the disclosed technology can determine the proximity of the vehicle by communicating with telematics units installed on the vehicle. In embodiments, the disclosed technology can turn on and off the event detection and data recording when the mobile device is mounted on or dismounted from a jig within the vehicle.

In embodiments, a sensor on the mobile device can be utilized to detect when the mobile device is in contact with a jig and determine whether the mobile device is mounted/dismounted from the jig. In embodiments, the disclosed technology can continuously monitor the temperature and battery life of the mobile device and turn the event detection and data recording when the mobile device is over-heating (detected based on data from built-in temperature sensor) or draining the battery at a fast rate (e.g., 10% of battery life used in 10 minutes of the disclosed technology running).

In embodiments, the disclosed technology can turn off the display of the mobile device to avoid distracting the driver when the vehicle is in operation. In one instance, the disclosed technology will display the video data being gathered to the driver to allow the driver to orient the mobile device at a proper angle and avoid recording the video in a distorted angle. Once the vehicle is in motion and crosses a particular speed (e.g., 20 mph), the disclosed technology will turn off the display to avoid distracting the driver. The particular speed at which the display is turned off can be dynamically determined based on the traffic condition, weather, vehicle's speed, terrain, etc. FIG. 2 provides an illustrative example 200 of a display of a smart phone 202, mounted on a windshield of a vehicle, which is turned off 202 when the vehicle reaches a speed of 20 mph.

As discussed above, in embodiments, an event can be manually triggered in the software application, which results in the video and other data being stored. In embodiments, the manual triggering can be performed by hand gestures, such as waving, or by tapping the display of the mobile device. Such simple modes of triggering an event reduce driver distraction. In embodiments, in response to a manual event trigger, the disclosed technology records a predefined duration of video and other data from the time of the detection of the manual event. In embodiments, in response to a manual event trigger, the disclosed technology records video and other data till another manual action, such as hand gestures or taps on the display, is detected to stop recording video and other data. In embodiments, in response to a manual event trigger, the disclosed technology continues to record data till the mobile device resources, such as battery, memory, etc., run out.

In embodiments, the disclosed technology can upload the stored video and other data into a remote storage service, such as a cloud storage service, any video sharing service, social-networking platforms (e.g., Facebook, YouTube, etc.), etc. In embodiments, the disclosed technology auto-compresses the video and other data before uploading the data, where the uploaded video and other data are only those related to recorded events. In embodiments, the disclosed technology can be limited to upload the video and other data only when on a local network (such as Wi-Fi) and not to use other data services available through the mobile device (such as 4G LTE data service), preventing use of expensive data bandwidth.

FIG. 3 is a flow diagram illustrating a method 300 for detecting an event based on the gathered data and storing the gathered data in response to the detected event. In block 302 of the method 300, a video of the proximity of a vehicle is captured using video cameras on a mobile device. Further, data sensed using various sensors with which the mobile device can communicate with is captured. In block 304, analyze the captured video and sensory data to detect any event of interest. In block 306, when an event is detected in block 304, the gathered data is stored. In embodiments, the stored data includes information associated with the detected data. Those skilled in the art will appreciate that the logic illustrated in FIG. 3 and described above may be altered in various ways. For example, the order of the logic may be rearranged, substeps may be performed in parallel, illustrated logic may be omitted, other logic may be included, etc.

FIG. 4 is a block diagram of a computer system as may be used to implement features of some embodiments of the disclosed technology. The computing system 400 may include one or more central processing units (“processors”) 405, memory 410, input/output devices 425 (e.g., keyboard and pointing devices, display devices), storage devices 420 (e.g., disk drives), and network adapters 430 (e.g., network interfaces) that are connected to an interconnect 415. The interconnect 415 is illustrated as an abstraction that represents any one or more separate physical buses, point to point connections, or both connected by appropriate bridges, adapters, or controllers. The interconnect 415, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 410 and storage devices 420 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media) and computer-readable transmission media.

The instructions stored in memory 410 can be implemented as software and/or firmware to program the processor(s) 405 to carry out actions described above. In some embodiments, such software or firmware may be initially provided to the processing system 400 by downloading it from a remote system through the computing system 400 (e.g., via network adapter 430).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the technology. Accordingly, the technology is not limited except as defined by the appended claims.

What is claimed is:

1. A method, comprising:
receiving, by a computing device with a processor, information related to operation of the vehicle by the driver, wherein the received information is gathered by monitoring the driver, the vehicle and the proximity of the vehicle during a period of operation of the vehicle by the driver;
analyzing, by the computing device, the received information to detect an event of interest, the event of interest being detected by comparing a value of a parameter associated with the event of interest to a predefined value of the parameter associated with a predefined event of interest, wherein a correlation between the value of the parameter and the predefined value of the parameter indicates a detection of the event of interest, the value of the parameter being based on the received information; and
storing, by the computing device, the received information.

2. The method of claim 1, wherein the monitoring of the driver, the vehicle and the proximity of the vehicle during the period of operation of the vehicle by the driver is performed using one or more cameras, the one or more cameras being mounted within the vehicle.

3. The method of claim 2, wherein a first camera of the one or more cameras is mounted with any display screen of the mobile device oriented towards the driver of the vehicle, wherein a second camera of the one or more cameras is oriented away from the driver.

4. The method of claim 1, wherein a given event of interest includes any of:
an unsafe vehicle operation;
an unusual object on a road;
a scenic view;
a traffic incident;
an unsafe changing of lanes by another vehicle in the proximity of the vehicle;
a drifting of the vehicle; and
a swerving of the vehicle.

5. The method of claim 2, wherein storing the received information includes storing a predefined duration of a video recorded by the one or more cameras.

6. The method of claim 1, wherein the monitoring of the driver, the vehicle and the proximity of the vehicle during the period of operation of the vehicle by the driver is performed using a sensor, wherein a given sensor includes any one of:
an accelerometer;
a microphone;
a temperature sensor;
an elevation sensor;
a proximity sensors;
a compass;
a gyroscope; and
a barometer.

7. A system, comprising:
a component configured to receive information related to operation of the vehicle by the driver, wherein the received information is gathered by monitoring the driver, the vehicle and the proximity of the vehicle during a period of operation of the vehicle by the driver;
a component configured to analyze the received information to detect an event of interest, the event of interest being detected by comparing a value of a parameter associated with the event of interest to a predefined value of the parameter associated with a predefined event of interest, wherein a correlation between the value of the parameter and the predefined value of the parameter indicates a detection of the event of interest, the value of the parameter being based on the received information; and
a component configured to store the received information.

8. The system of claim 7, wherein the monitoring of the driver, the vehicle and the proximity of the vehicle during the period of operation of the vehicle by the driver is performed using one or more cameras, the one or more cameras being mounted within the vehicle.

9. The system of claim 8, wherein a first camera of the one or more cameras is mounted with any display screen of the mobile device oriented towards the driver of the vehicle, wherein a second camera of the one or more cameras is oriented away from the driver.

10. The system of claim 7, wherein a given event of interest includes any of:
an unsafe vehicle operation;
an unusual object on a road;
a scenic view;
a traffic incident;
an unsafe changing of lanes by another vehicle in the proximity of the vehicle;
a drifting of the vehicle; and
a swerving of the vehicle.

11. The system of claim 8, wherein storing the received information includes storing a predefined duration of a video recorded by the one or more cameras.

12. The system of claim 7, wherein the monitoring of the driver, the vehicle and the proximity of the vehicle during the period of operation of the vehicle by the driver is performed using a sensor, wherein a given sensor includes any one of:
an accelerometer;
a microphone;
a temperature sensor;
an elevation sensor;
a proximity sensors;
a compass;
a gyroscope; and
a barometer.

13. A computer readable storage medium storing computer executable instructions, comprising:
instructions for receiving information related to operation of the vehicle by the driver, wherein the received information is gathered by monitoring the driver, the vehicle and the proximity of the vehicle during a period of operation of the vehicle by the driver;
instructions for analyzing the received information to detect an event of interest, the event of interest being detected by comparing a value of a parameter associated with the event of interest to a predefined value of the parameter associated with a predefined event of interest, wherein a correlation between the value of the parameter and the predefined value of the parameter indicates a detection of the event of interest, the value of the parameter being based on the received information; and
instructions for storing the received information.

14. The computer readable storage medium of claim 13, wherein the monitoring of the driver, the vehicle and the proximity of the vehicle during the period of operation of the vehicle by the driver is performed using one or more cameras, the one or more cameras being mounted within the vehicle.

15. The computer readable storage medium of claim 14, wherein a first camera of the one or more cameras is mounted with any display screen of the mobile device oriented towards the driver of the vehicle, wherein a second camera of the one or more cameras is oriented away from the driver.

16. The computer readable storage medium of claim 12, wherein a given event of interest includes any of:
an unsafe vehicle operation;
an unusual object on a road;
a scenic view;
a traffic incident;
an unsafe changing of lanes by another vehicle in the proximity of the vehicle;
a drifting of the vehicle; and
a swerving of the vehicle.

17. The computer readable storage medium of claim 14, wherein storing the received information includes storing a predefined duration of a video recorded by the one or more cameras.

18. The computer readable storage medium of claim 13, wherein the monitoring of the driver, the vehicle and the proximity of the vehicle during the period of operation of the vehicle by the driver is performed using a sensor, wherein a given sensor includes any one of:
an accelerometer;
a microphone;
a temperature sensor;
an elevation sensor;
a proximity sensors;
a compass;
a gyroscope; and
a barometer.
